(19) United States
(12) Patent Application Publication
(10) Pub. No.: US 2025/0251058 A1
(43) Pub. Date: Aug. 7, 2025

(54) DEVICE FOR PREVENTING BREAKAGE OF DIAPHRAGM FOR NORMAL-OPEN SOLENOID VALVE

(71) Applicant: KYUNGDONG NAVIEN CO., LTD., Gyeonggi-do (KR)

(72) Inventor: Min Seop OH, Seoul (KR)

(73) Assignee: KYUNGDONG NAVIEN CO., LTD., Gyeonggi-do (KR)

(21) Appl. No.: 19/042,251

(22) Filed: Jan. 31, 2025

(30) Foreign Application Priority Data
Feb. 2, 2024 (KR) 10-2024-0016919
Dec. 19, 2024 (KR) 10-2024-0191584

(51) Int. Cl. F16K 39/02; F16K 7/16; F16K 31/06

(52) U.S. Cl. CPC F16K 39/022; F16K 7/16; F16K 31/0672

(57) ABSTRACT

The present disclosure provides a device for preventing breakage of a diaphragm for a normal-open solenoid valve, the device including a pressure transmission prevention means installed in an inlet region of a square hole and configured to prevent pressure, which is generated by a fluid, from being transmitted to a diaphragm in order to prevent the diaphragm from being broken by pressure applied to the diaphragm by the fluid introduced through the center hole and passing through the square hole.

### CROSS-REFERENCE TO RELATED APPLICATION

This application claims priority to and the benefit of Korean Patent Application No. 10-2024-0016919 filed in the Korean Intellectual Property Office on Feb. 2, 2024 and No. 10-2024-0191584 filed in the Korean Intellectual Property Office on Dec. 19, 2024 the entire contents of which are incorporated herein by reference.

### TECHNICAL FIELD

The present disclosure relates to a device for preventing breakage of a diaphragm for a normal-open solenoid valve, and more particularly, to a device for preventing breakage of a diaphragm for a normal-open solenoid valve, the device being capable of preventing a diaphragm from being expanded and broken by pressure applied to the diaphragm when backpressure is generated in a normal-open solenoid valve when the normal-open solenoid valve operates.

### BACKGROUND ART

FIG. 1A and FIG. 1B are a perspective view illustrating a structure in which a diaphragm is broken by being expanded by backpressure generated in a normal-open solenoid valve in the related art.

As illustrated in FIG. 1A, the normal-open solenoid valve in the related art has a valve cover 2 having a center hole 2a formed through the valve cover 2, having a water inlet portion through which water is introduced, and a water outlet portion through which the introduced water is discharged, and configured as a center passageway through which the water flows, the valve cover 2 having a square hole 2b formed through the valve cover 2, provided at one side of the valve cover 2, and configured as a passageway configured to communicate with a space in which a diaphragm 1 is installed.

Further, a plunger 4 is assembled to the valve cover 2, installed between the water inlet portion and the water outlet portion, and configured to be movable upward or downward. The plunger 4 is configured to selectively open or close the center hole 2a while moving upward or downward so that the water introduced through the water inlet portion may be selectively discharged through the water outlet portion. A plunger guide 5 is assembled to the valve cover 2 and configured to guide the upward and downward movements of the plunger 4.

In addition, the diaphragm 1 made of a flexible material is installed at one side of the space communicating with the square hole 2b and separates the water inlet portion and the water outlet portion.

However, as illustrated in FIG. 1B, in the normal-open solenoid valve in the related art having the above-mentioned structure, when a fluid flows reversely through the center hole 2a, the fluid, which flows reversely, may be introduced into the space, in which the diaphragm 1 is installed, through the square hole 2b, and backpressure may be applied to the diaphragm 1. When the backpressure is applied to the diaphragm 1, the diaphragm 1 may be expanded and broken. However, there is no structure capable of preventing breakage of the diaphragm 1 when the backpressure is generated.

### SUMMARY

The present disclosure has been made in an effort to provide a device for preventing breakage of a diaphragm for a normal-open solenoid valve, the device being capable of preventing a diaphragm from being expanded and broken by pressure applied to the diaphragm when backpressure is generated in a normal-open solenoid valve when the normal-open solenoid valve operates.

In order to achieve the above-mentioned object, the present disclosure provides a device for preventing breakage of a diaphragm for a normal-open solenoid valve, the device including: a valve cover having a center hole formed through the valve cover, provided between a water inlet portion, through which water is introduced, and a water outlet portion, through which the introduced water is discharged, configured as a center passageway through which the water flows, and configured to be adjusted to be opened or closed by a diaphragm so that the water introduced into the water inlet portion is selectively discharged to the water outlet portion, the valve cover having a square hole provided at one side of the valve cover, formed through the valve cover, and configured as a passageway configured to communicate with a space in which the diaphragm is installed; and a pressure transmission prevention means installed in an inlet region of the square hole and configured to prevent pressure, which is generated by a fluid, from being transmitted to the diaphragm in order to prevent the diaphragm from being broken by pressure applied to the diaphragm by the fluid introduced through the center hole and passing through the square hole.

In this case, the pressure transmission prevention means may include: a flap including a plate-shaped member configured to move upward or downward so as to selectively come into contact with a peripheral edge portion of the square hole and having a diameter relatively larger than a diameter of the square hole, and an extension member extending by a predetermined length from a lower portion of the plate-shaped member, configured to be inserted into the square hole, and having a communication space; and a flap guide installed above the flap and configured to guide and restrict the upward and downward movements of the flap.

Further, the communication space may be formed by partially cutting a lateral surface of the extension member in a height direction so that a part of the square hole is opened when the plate-shaped member is separated from the peripheral edge portion of the square hole.

In addition, the extension member may be formed to have a ‘+’-shaped transverse section and have a width so that front, rear, left, and right surfaces of the extension member come into contact with the square hole.

Further, the flap guide may include: a support member having a predetermined height and configured to be brought into contact with and supported on an upper peripheral surface of the square hole around a peripheral edge portion of the flap; and a restriction member provided at an upper end of the support member and configured to restrict a height by which the flap moves upward or downward.

Further, a height of the support member formed on the flap guide may be relatively smaller than a length of the extension member.

In addition, a height of the restriction member may be set to a height that allows the restriction member to come into contact with a lower surface of a plunger guide coupled to an upper surface of the valve cover to prevent an inadvertent movement.

Further, the flap guide may be formed to have an outer diameter equal to an inner diameter of the valve cover, and the flap guide may be configured as a cylindrical member having a guide groove recessed in a lower surface thereof so that the flap is selectively inserted into the guide groove.

Further, a height of the guide groove may be relatively smaller than a height of the extension member.

A height of the flap guide may be set to a thickness that allows the flap guide to come into contact with a lower surface of a plunger guide coupled to an upper surface of the valve cover to prevent an inadvertent movement.

Further, a separate guide packing may be installed between a periphery of a central region of a lower portion of the flap guide and a peripheral edge portion of the center hole formed in the valve cover.

Further, the pressure transmission prevention means may include: a fixing portion fixed to one side of the peripheral edge portion of the square hole; and a cover portion integrated with the fixing portion and having a lower surface configured to be selectively brought into contact with or separated from the peripheral edge portion of the square hole depending on a direction of applied pressure.

In addition, cut-out grooves, which are cut inward, may be provided at two opposite sides of a boundary region between the fixing portion and the cover portion.

Further, a sealing member may protrude by a predetermined length from the lower surface of the cover portion, and the sealing member may be inserted into the square hole and comes into contact with a periphery of an inner surface of the square hole when the cover portion comes into contact with the peripheral edge portion of the square hole.

A fixing rib may protrude from one side of a lower surface of a plunger guide coupled to an upper surface of the valve cover, and the fixing rib may press and fix an upper surface of the fixing portion when the plunger guide is coupled to the upper surface of the valve cover.

In addition, the fixing portion may be formed in a ring shape, and the fixing rib may be provided as a plurality of fixing ribs that protrude along an annular shape from a plurality of points to press the fixing portion at the plurality of points.

As described above, the device for preventing breakage of a diaphragm for a normal-open solenoid valve according to the present disclosure may prevent the diaphragm from being expanded and broken by backpressure applied to the diaphragm when the backpressure is generated in the normal-open solenoid valve when the normal-open solenoid valve operates.

Further, the device for preventing breakage of a diaphragm for a normal-open solenoid valve according to the present disclosure is implemented by the simple structure installed on the peripheral edge portion of the square hole and configured to operate without hindering a flow of the fluid when positive pressure is generated and operate while accurately preventing backpressure from being transmitted to the diaphragm when the backpressure is generated, such that the device for preventing breakage of a diaphragm for a normal-open solenoid valve according to the present disclosure may be quickly and easily installed.

### BRIEF DESCRIPTION OF THE DRAWINGS

FIG. 1A and FIG. 1B are a perspective view illustrating a structure in which a diaphragm is broken by being expanded by backpressure generated in a normal-open solenoid valve in the related art.

FIG. 2 is a perspective view illustrating a structure in which a structure of a device for preventing breakage of a diaphragm for a normal-open solenoid valve according to a first embodiment of the present disclosure is installed.

FIG. 3 is an exploded perspective view illustrating a structure in which the device for preventing breakage of a diaphragm for a normal-open solenoid valve according to the first embodiment of the present disclosure is disassembled.

FIG. 4 is a perspective view illustrating a structure of a flap of the device for preventing breakage of a diaphragm for a normal-open solenoid valve according to the first embodiment of the present disclosure.

FIG. 5 is a perspective view illustrating a structure of a flap guide of the device for preventing breakage of a diaphragm for a normal-open solenoid valve according to the first embodiment of the present disclosure.

FIG. 6A and FIG. 6B are an operational view illustrating an operation of the device for preventing breakage of a diaphragm for a normal-open solenoid valve according to the first embodiment of the present disclosure.

FIG. 7 is a perspective view illustrating a structure in which a device for preventing breakage of a diaphragm for a normal-open solenoid valve according to a second embodiment of the present disclosure is installed.

FIG. 8 is an exploded perspective view illustrating a structure in which the device for preventing breakage of a diaphragm for a normal-open solenoid valve according to the second embodiment of the present disclosure is disassembled.

FIG. 9A and FIG. 9B are an operational view illustrating an operation of the device for preventing breakage of a diaphragm for a normal-open solenoid valve according to the second embodiment of the present disclosure.

FIG. 10 is a perspective view illustrating a structure in which a device for preventing breakage of a diaphragm for a normal-open solenoid valve according to a third embodiment of the present disclosure is installed.

FIG. 11 is a perspective view illustrating a structure of a flap of the device for preventing breakage of a diaphragm for a normal-open solenoid valve according to the third embodiment of the present disclosure.

FIG. 12 is a perspective view illustrating a structure in which a device for preventing breakage of a diaphragm for a normal-open solenoid valve according to a fourth embodiment of the present disclosure is installed.

FIG. 13 is a perspective view illustrating a structure of a flap of the device for preventing breakage of a diaphragm for a normal-open solenoid valve according to the fourth embodiment of the present disclosure.

FIG. 14 is a perspective view illustrating a structure of a plunger guide of the device for preventing breakage of a diaphragm for a normal-open solenoid valve according to the fourth embodiment of the present disclosure.

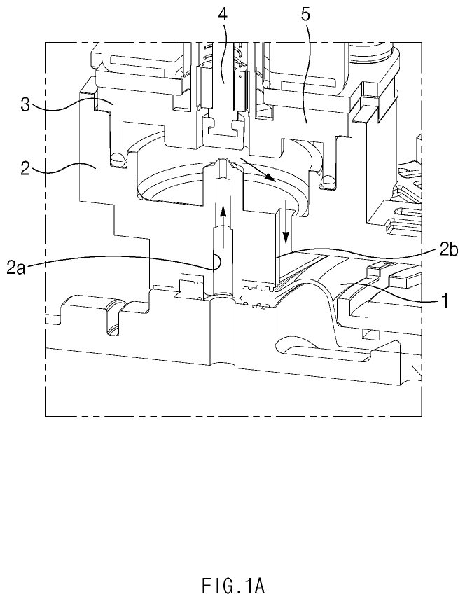

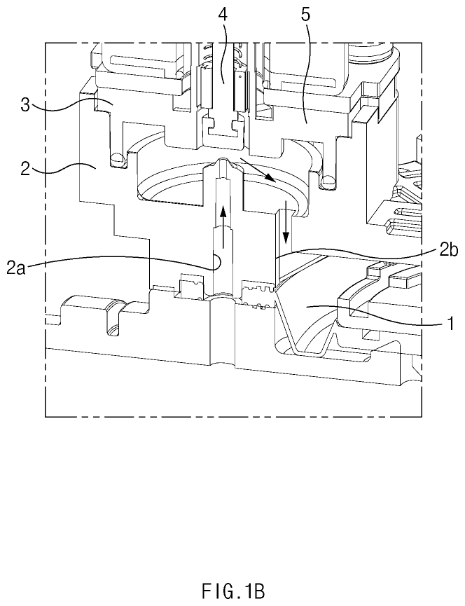

### DETAILED DESCRIPTION

Hereinafter, an energy generation device according to an embodiment of the present disclosure will be described in more detail with reference to the accompanying drawings.

However, the technical spirit of the present disclosure is not limited to some embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

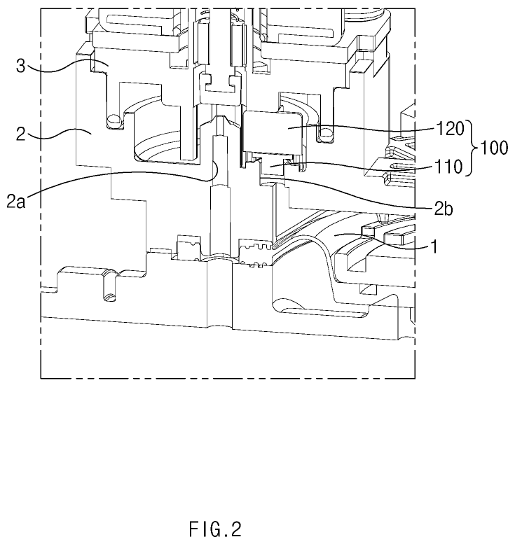

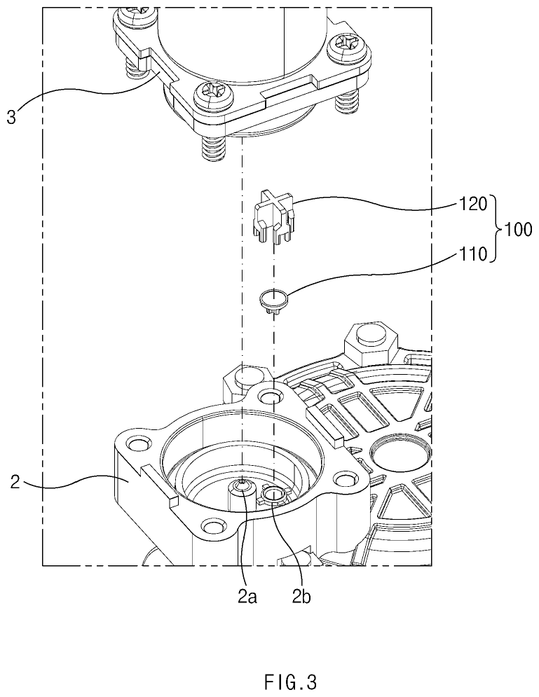

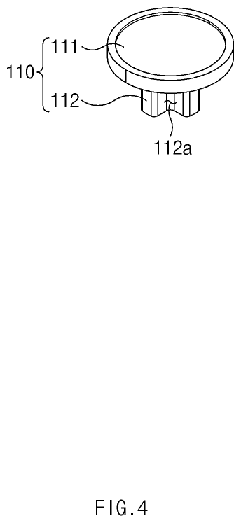

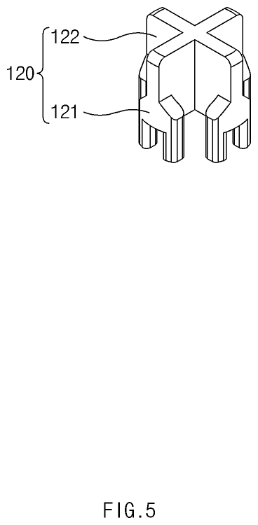

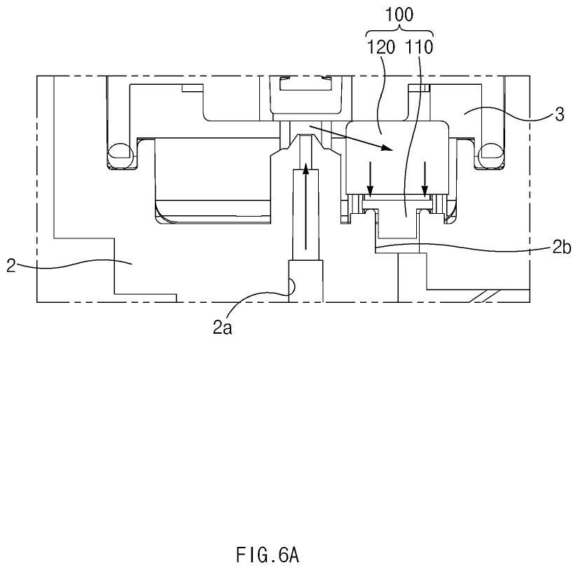

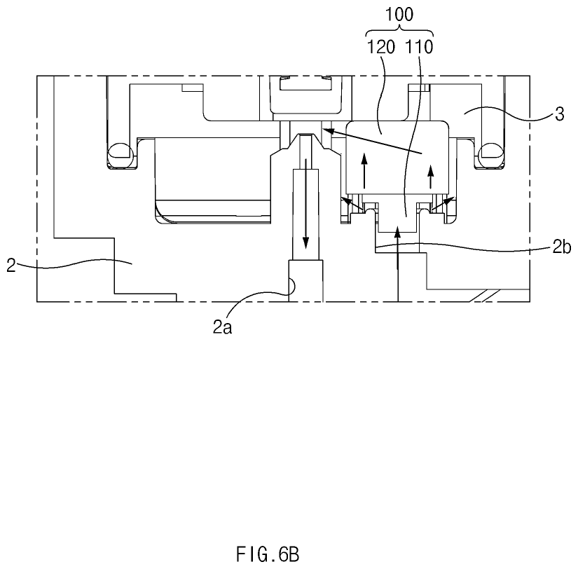

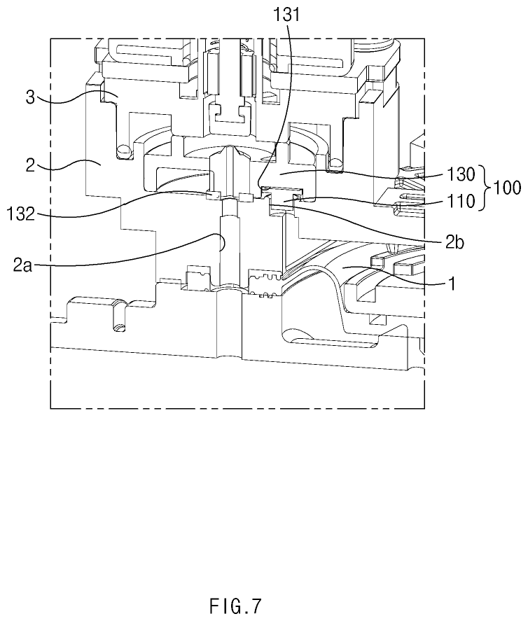

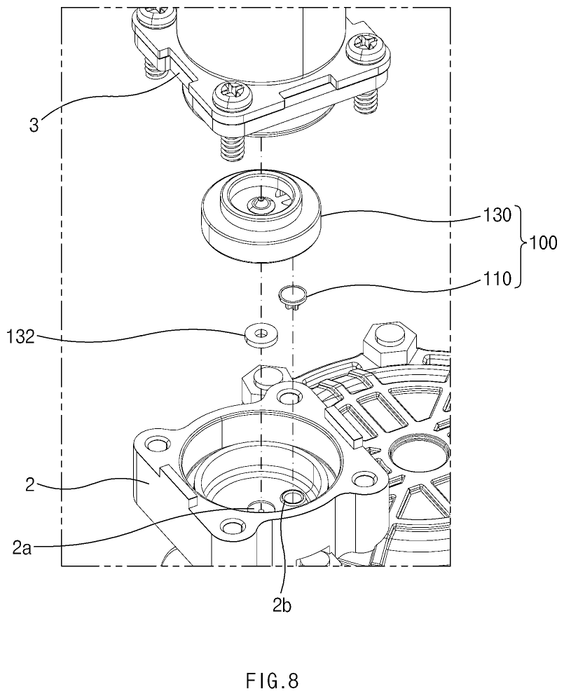

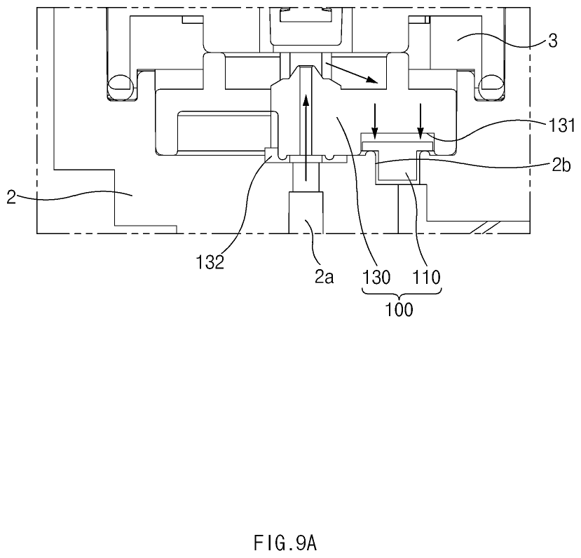

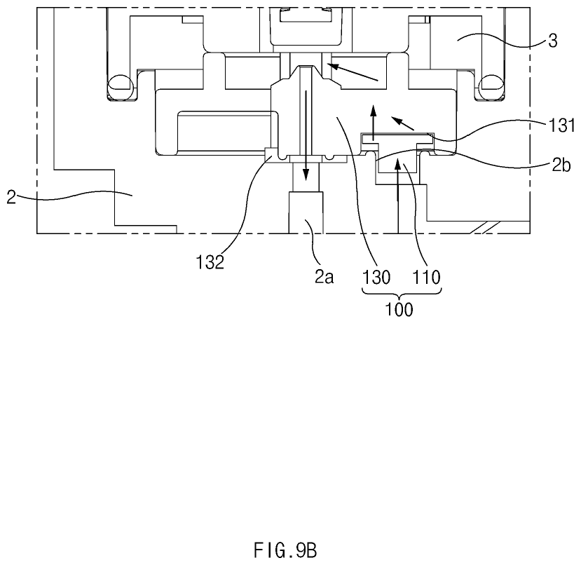

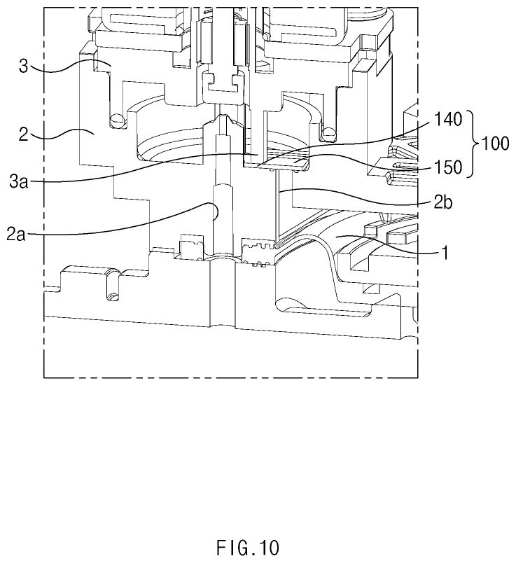

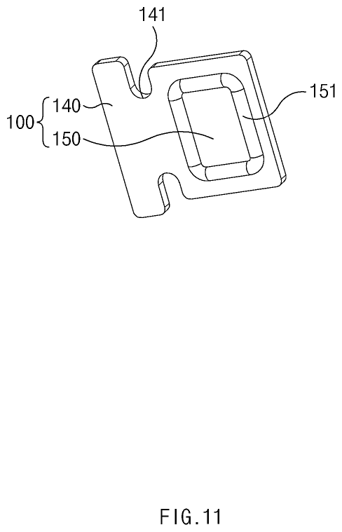

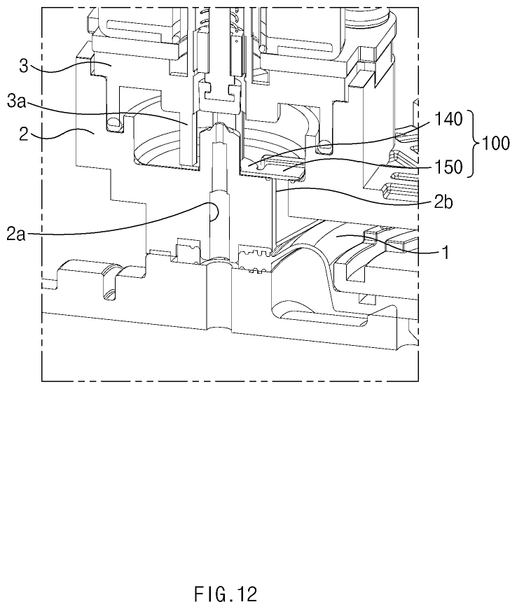

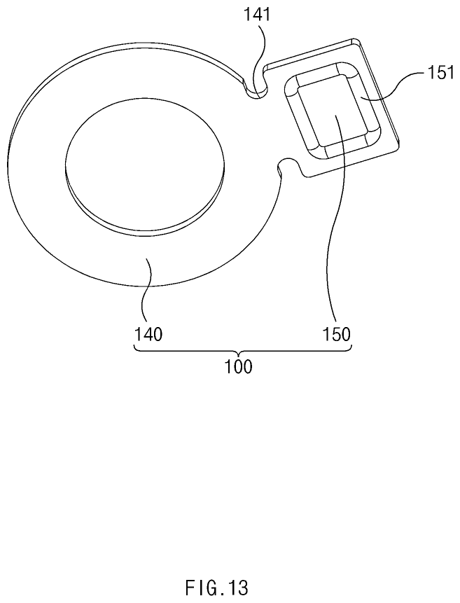

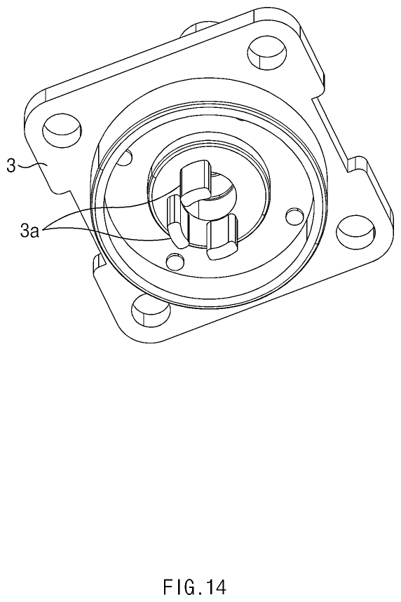

FIG. 2 is a perspective view illustrating a structure in which a structure of a device for preventing breakage of a diaphragm for a normal-open solenoid valve according to a first embodiment of the present disclosure is installed, FIG. 3 is an exploded perspective view illustrating a structure in which the device for preventing breakage of a diaphragm for a normal-open solenoid valve according to the first embodiment of the present disclosure is disassembled, FIG. 4 is a perspective view illustrating a structure of a flap of the device for preventing breakage of a diaphragm for a normal-open solenoid valve according to the first embodiment of the present disclosure, FIG. 5 is a perspective view illustrating a structure of a flap guide of the device for preventing breakage of a diaphragm for a normal-open solenoid valve according to the first embodiment of the present disclosure, FIG. 6A and FIG. 6B are an operational view illustrating an operation of the device for preventing breakage of a diaphragm for a normal-open solenoid valve according to the first embodiment of the present disclosure, FIG. 7 is a perspective view illustrating a structure in which a device for preventing breakage of a diaphragm for a normal-open solenoid valve according to a second embodiment of the present disclosure is installed, FIG. 8 is an exploded perspective view illustrating a structure in which the device for preventing breakage of a diaphragm for a normal-open solenoid valve according to the second embodiment of the present disclosure is disassembled, FIG. 9A and FIG. 9B are an operational view illustrating an operation of the device for preventing breakage of a diaphragm for a normal-open solenoid valve according to the second embodiment of the present disclosure, FIG. 10 is a perspective view illustrating a structure in which a device for preventing breakage of a diaphragm for a normal-open solenoid valve according to a third embodiment of the present disclosure is installed, FIG. 11 is a perspective view illustrating a structure of a flap of the device for preventing breakage of a diaphragm for a normal-open solenoid valve according to the third embodiment of the present disclosure, FIG. 12 is a perspective view illustrating a structure in which a device for preventing breakage of a diaphragm for a normal-open solenoid valve according to a fourth embodiment of the present disclosure is installed, FIG. 13 is a perspective view illustrating a structure of a flap of the device for preventing breakage of a diaphragm for a normal-open solenoid valve according to the fourth embodiment of the present disclosure, FIG. 14 is a perspective view illustrating a structure of a plunger guide of the device for preventing breakage of a diaphragm for a normal-open solenoid valve according to the fourth embodiment of the present disclosure.

As illustrated in the drawings, the device for preventing breakage of a diaphragm for a normal-open solenoid valve according to the present disclosure includes a valve cover 2 having a center hole 2a formed through the valve cover 2, provided between a water inlet portion, through which water is introduced, and a water outlet portion, through which the introduced water is discharged, configured as a center passageway through which the water flows, and configured to be adjusted to be opened or closed by a diaphragm 1 so that the water introduced into the water inlet portion is selectively discharged to the water outlet portion, the valve cover 2 having a square hole 2b provided at one side of the valve cover 2, formed through the valve cover 2, and configured as a passageway configured to communicate with a space in which the diaphragm 1 is installed. The device for preventing breakage of a diaphragm for a normal-open solenoid valve according to the present disclosure includes a pressure transmission prevention means 100 installed in an inlet region of the square hole 2b and configured to prevent pressure, which is generated by a fluid, from being transmitted to the diaphragm 1 in order to prevent the diaphragm 1 from being broken by pressure applied to the diaphragm 1 by the fluid introduced through the center hole 2a and passing through the square hole 2b.

As illustrated in FIGS. 2 to 9A and 9B, the pressure transmission prevention means 100 according to the first and second embodiments of the present disclosure may include a flap 110 including a plate-shaped member 111 configured to move upward or downward so as to selectively come into contact with a peripheral edge portion of the square hole 2b and having a diameter relatively larger than a diameter of the square hole 2b, and an extension member 112 extending by a predetermined length from a lower portion of the plate-shaped member 111, configured to be inserted into the square hole 2b, and having a communication space 112a, and a flap guide 120 or 130 installed above the flap 110 and configured to guide and restrict the upward and downward movements of the flap 110.

The flap 110 of the pressure transmission prevention means 100 according to the first embodiment of the present disclosure is installed in the square hole 2b formed at one side of the valve cover 2 and serves to prevent pressure from being transmitted to the diaphragm 1 through the square hole 2b when the backpressure is generated.

The pressure transmission prevention means 100 broadly includes the flap 110, and the flap guide 120 installed above the flap 110.

As illustrated in FIG. 4, the flap 110 includes the plate-shaped member 111 configured to move upward or downward so as to selectively come into contact with the peripheral edge portion of the square hole 2b and having a diameter relatively larger than a diameter of the square hole 2b, and the extension member 112 extending by a predetermined length from the lower portion of the plate-shaped member 111, configured to be inserted into the square hole 2b, and having the communication space 112a.

The plate-shaped member 111 is formed in a disk shape. When the flap 110 moves upward or downward, the plate-shaped member 111 selectively comes into contact with the peripheral edge portion of the square hole 2b and substantially serves to prevent the backpressure from being transmitted to the diaphragm 1 through the square hole 2b.

To this end, it is effective that the plate-shaped member 111 is formed to have an area to the extent that the plate-shaped member 111 may sufficiently block an entire upper side of the square hole 2b from the outside.

The extension member 112 refers to a member integrated with the plate-shaped member 111 and extending downward by a predetermined length. The extension member 112 may have the communication space 112a formed at one side thereof so that the fluid may flow through the square hole 2b when the plate-shaped member 111 is separated from the peripheral edge portion of the square hole 2b as positive pressure is applied.

The communication space 112a may be formed by partially cutting a lateral surface of the extension member 112 in a height direction so that a part of the square hole 2b is opened when the plate-shaped member 111 is separated from the peripheral edge portion of the square hole 2b.

The extension member 112, which constitutes the pressure transmission prevention means according to the first embodiment of the present disclosure, is formed to have a ‘+’-shaped transverse section. It is effective that the extension member 112 has a width so that front, rear, left, and right surfaces of the extension member 112 come into contact with the square hole 2b, such that the extension member 112 does not move inadvertently when the flap 110 moves upward or downward.

As illustrated in FIG. 5, the flap guide 120 may include support members 121 each having a predetermined height and configured to be brought into contact with and supported on an upper peripheral surface of the square hole 2b around a peripheral edge portion of the flap 110, and a restriction member 122 provided at upper ends of the support members 121 and configured to restrict a height by which the flap 110 moves upward or downward.

The support members 121 may be disposed to face one another and spaced apart from one another to the extent that the flap 110 may be disposed inside the support members 121. Two pairs of support members 121 may be installed at front, rear, left, and right sides. A height of the support member 121 may be relatively smaller than a length of the extension member 112.

Because the height of the support member 121 is relatively smaller than the length of the extension member 112, the support member 121 may be prevented from being separated from the square hole 2b when the flap 110 moves upward or downward.

Further, it is effective that the height of the restriction member 122 may be set to a height that may allow the restriction member 122 to come into contact with and press a lower surface of a plunger guide 3 coupled to an upper surface of the valve cover 2, thereby preventing an inadvertent movement of the entire flap guide 120.

Because the flap 110 according to the second embodiment of the present disclosure is identical in shape to the flap 110 according to the first embodiment of the present disclosure, a detailed description thereof will be omitted.

As illustrated in FIGS. 7 to 9A and 9B, the flap guide 130 according to the second embodiment of the present disclosure may be configured as a cylindrical member formed to have an outer diameter equal to an inner diameter of the valve cover 2 and having a guide groove 131 recessed in a lower surface of the flap guide 130 so that the flap 110 is selectively inserted into the guide groove 131.

The flap guide 130 according to the second embodiment of the present disclosure is installed by being inserted into an inner diameter portion formed in the valve cover 2, such that the flap 110 may be prevented from being completely separated from the square hole 2b, and the height by which the flap 110 moves upward or downward may be restricted.

To this end, a height of the guide groove 131 formed in the flap guide 130 is relatively smaller than a height of the extension member 112, such that the flap 110 may be prevented from being completely separated from the square hole 2b, and the height by which the flap 110 moves upward or downward may be restricted.

Further, it is effective that the height of the flap guide 130 may be set to a thickness that may allow the flap guide 130 to come into contact with the lower surface of the plunger guide 3 coupled to the upper surface of the valve cover 2, thereby preventing an inadvertent movement of the flap guide 130.

In addition, a separate guide packing 132 may be installed between a periphery of a central region of a lower portion of the flap guide 130 and a peripheral edge portion of the center hole 2a formed in the valve cover 2, such that the fluid flowing through the center hole 2a may be prevented from leaking to the outside through a gap between the center hole 2a and the flap guide 130.

A process of operating the device for preventing breakage of a diaphragm for a normal-open solenoid valve according to the first and second embodiments of the present disclosure configured as described above will be described below with reference to FIGS. 6 and 9.

Preferentially, as illustrated in FIGS. 6B and 9B, in case that pressure is applied in a forward direction in the normal-open solenoid valve, the fluid passing through the solenoid valve flows upward through the square hole 2b, and the flap 110 is moved upward by positive pressure. When the plate-shaped member 111 is separated from the peripheral edge portion of the square hole 2b as the flap 110 moves upward, the communication space 112a may be opened, and the fluid may flow through the communication space 112a and be discharged through the water outlet portion.

In this case, the flap guide 120 or 130 installed above the flap 110 restricts the height by which the flap 110 moves upward or downward, such that the flap 110 may be prevented from being completely separated from the square hole 2b, and the movement of the flap 110 may be stably guided.

As illustrated in FIGS. 6A and 9A, in case that pressure is applied in a reverse direction in the normal-open solenoid valve, it is necessary to prevent the fluid passing through the solenoid valve from flowing downward through the square hole 2b and damaging the diaphragm 1.

When the backpressure is applied, the flap 110 is moved downward by the backpressure, and the plate-shaped member 111 is tightly attached to the peripheral edge portion of the square hole 2b as the flap 110 is moved downward, such that the square hole 2b is fully closed. Therefore, the fluid cannot flow in the reverse direction, thereby preventing breakage of the diaphragm 1.

Meanwhile, as illustrated in FIGS. 10 and 11, the pressure transmission prevention means 100 of the device for preventing breakage of a diaphragm for a normal-open solenoid valve according to the third embodiment of the present disclosure includes a fixing portion 140 fixed to one side of the peripheral edge portion of the square hole 2b, and a cover portion 150 integrated with the fixing portion 140 and having a lower surface configured to be selectively brought into contact with or separated from the peripheral edge portion of the square hole 2b depending on a direction of applied pressure.

The fixing portion 140 is formed in a plate shape. The fixing portion 140 is in contact with the lower surface of the valve cover 2 at one side of the peripheral edge portion of the square hole 2b. The fixing portion 140 is fixed by a fixing rib 3a. The fixing rib 3a protrudes from one side of the lower surface of the plunger guide 3 coupled to the upper surface of the valve cover 2 and is configured to press an upper surface of the fixing portion 140 when the plunger guide 3 is coupled to the upper surface of the valve cover 2.

As illustrated in FIGS. 12 to 14, the fixing portion 140, which constitutes the device for preventing breakage of a diaphragm for a normal-open solenoid valve according to the fourth embodiment of the present disclosure, may be formed in a ring shape. The plurality of fixing ribs 3a may protrude along an annular shape from a plurality of points to press the fixing portion 140 at the plurality of points.

In case that the fixing portion 140 is formed in a ring shape, an initial position of the fixing portion 140 may be conveniently set when the fixing portion 140 is assembled. Further, it is possible to assuredly prevent the position of the fixing portion 140 from being arbitrarily changed.

In the state in which the fixing portion 140 is fixed by the fixing rib 3a, the cover portion 150 is kept in contact with the peripheral edge portion of the square hole 2b.

Further, it is effective that cut-out grooves 141, which are cut inward, may be provided at two opposite sides of a boundary region between the fixing portion 140 and the cover portion 150 so that when positive pressure is applied, the cover portion 150 may be easily folded with respect to the fixing portion 140, the cover portion 150 may be separated from the peripheral edge portion of the square hole 2b, and the fluid may flow.

In addition, a sealing member 151 may protrude by a predetermined length from a lower surface of the cover portion 150. When the cover portion 150 comes into contact with the peripheral edge portion of the square hole 2b, the sealing member 151 is inserted into the square hole 2b and comes into contact with a periphery of an inner surface of the square hole 2b, such that the lower surface of the cover portion 150 and an inlet of the square hole 2b may be in close contact with each other.

In the device for preventing breakage of a diaphragm for a normal-open solenoid valve according to the third and fourth embodiments of the present disclosure configured as described above, when positive pressure is applied in the solenoid valve, the cover portion 150 is folded at a predetermined angle with respect to the fixing portion 140, the cover portion 150 is separated from the square hole 2b, and the square hole 2b is opened, such that the fluid may flow and be discharged through the water outlet portion.

Further, when the backpressure is generated in the solenoid valve, the cover portion 150 is tightly attached to the peripheral edge portion of the upper portion of the square hole 2b by the backpressure, and the square hole 2b is closed, such that the backpressure is not transmitted to the diaphragm 1, thereby preventing breakage of the diaphragm 1.

The device for preventing breakage of a diaphragm for a normal-open solenoid valve according to the present disclosure configured as described above may prevent the diaphragm from being expanded and broken by backpressure applied to the diaphragm when the backpressure is generated in the normal-open solenoid valve when the normal-open solenoid valve operates.

While the embodiments, which may be implemented by the present disclosure, have been described above, the embodiments are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the embodiments may be modified and then carried out. Further, it should be interpreted that the differences related to the modifications and applications are included in the scope of the present disclosure defined by the appended claims.

What is claimed is:

1. A device for preventing breakage of a diaphragm for a normal-open solenoid valve, the device comprising:
a valve cover having a center hole formed through the valve cover, provided between a water inlet portion, through which water is introduced, and a water outlet portion, through which the introduced water is discharged, configured as a center passageway through which the water flows, and configured to be adjusted to be opened or closed by a diaphragm so that the water introduced into the water inlet portion is selectively discharged to the water outlet portion, the valve cover having a square hole provided at one side of the valve cover, formed through the valve cover, and configured as a passageway configured to communicate with a space in which the diaphragm is installed; and
a pressure transmission prevention means installed in an inlet region of the square hole and configured to prevent pressure, which is generated by a fluid, from being transmitted to the diaphragm in order to prevent the diaphragm from being broken by pressure applied to the diaphragm by the fluid introduced through the center hole and passing through the square hole.

2. The device of claim 1, wherein the pressure transmission prevention means comprises:
a flap comprising a plate-shaped member configured to move upward or downward so as to selectively come into contact with a peripheral edge portion of the square hole and having a diameter relatively larger than a diameter of the square hole, and an extension member extending by a predetermined length from a lower portion of the plate-shaped member, configured to be inserted into the square hole, and having a communication space; and
a flap guide installed above the flap and configured to guide and restrict the upward and downward movements of the flap.

3. The device of claim 2, wherein the communication space is formed by partially cutting a lateral surface of the extension member in a height direction so that a part of the square hole is opened when the plate-shaped member is separated from the peripheral edge portion of the square hole.

4. The device of claim 3, wherein the extension member is formed to have a ‘+’-shaped transverse section and has a width so that front, rear, left, and right surfaces of the extension member come into contact with the square hole.

5. The device of claim 2, wherein the flap guide comprises:
a support member having a predetermined height and configured to be brought into contact with and supported on an upper peripheral surface of the square hole around a peripheral edge portion of the flap; and
a restriction member provided at an upper end of the support member and configured to restrict a height by which the flap moves upward or downward.

6. The device of claim 5, wherein a height of the support member formed on the flap guide is relatively smaller than a length of the extension member.

7. The device of claim 5, wherein a height of the restriction member is set to a height that allows the restriction member to come into contact with a lower surface of a plunger guide coupled to an upper surface of the valve cover to prevent an inadvertent movement.

8. The device of claim 2, wherein the flap guide is formed to have an outer diameter equal to an inner diameter of the valve cover, and the flap guide is configured as a cylindrical member having a guide groove recessed in a lower surface thereof so that the flap is selectively inserted into the guide groove.

9. The device of claim 8, wherein a height of the guide groove is relatively smaller than a height of the extension member.

10. The device of claim 8, wherein a height of the flap guide is set to a thickness that allows the flap guide to come into contact with a lower surface of a plunger guide coupled to an upper surface of the valve cover to prevent an inadvertent movement.

11. The device of claim 8, wherein a separate guide packing is installed between a periphery of a central region of a lower portion of the flap guide and a peripheral edge portion of the center hole formed in the valve cover.

12. The device of claim 2, wherein the pressure transmission prevention means comprises:
a fixing portion fixed to one side of the peripheral edge portion of the square hole; and
a cover portion integrated with the fixing portion and having a lower surface configured to be selectively brought into contact with or separated from the peripheral edge portion of the square hole depending on a direction of applied pressure.

13. The device of claim 12, wherein cut-out grooves, which are cut inward, are provided at two opposite sides of a boundary region between the fixing portion and the cover portion.

14. The device of claim 12, wherein a sealing member protrudes by a predetermined length from the lower surface of the cover portion, and the sealing member is inserted into the square hole and comes into contact with a periphery of an inner surface of the square hole when the cover portion comes into contact with the peripheral edge portion of the square hole.

15. The device of claim 12, wherein a fixing rib protrudes from one side of a lower surface of a plunger guide coupled to an upper surface of the valve cover, and the fixing rib presses and fixes an upper surface of the fixing portion when the plunger guide is coupled to the upper surface of the valve cover.

16. The device of claim 15, wherein the fixing portion is formed in a ring shape, and the fixing rib is provided as a plurality of fixing ribs that protrude along an annular shape from a plurality of points to press the fixing portion at the plurality of points.
